(19) United States
(12) Patent Application Publication
(10) Pub. No.: US 2026/0059052 A1
(43) Pub. Date: Feb. 26, 2026

(54) ARTIFICIAL INTELLIGENCE-BASED REAL TIME VOICE CALL THROTTLING

(71) Applicant: BANK OF AMERICA CORPORATION, Charlotte, NC (US)

(72) Inventors: Nipun Mahajan, Lawrenceville, NJ (US); Robert Lutzkow, Phillipsburg, NJ (US); Amit Mishra, Chennai (IN); Saravana Prakash Kumaresan, Plainsboro, NJ (US); Sushama Shelke, Mumbai (IN)

(73) Assignee: BANK OF AMERICA CORPORATION, Charlotte, NC (US)

(21) Appl. No.: 18/815,361

(22) Filed: Aug. 26, 2024

(51) Int. Cl. H04M 3/523; H04M 3/51

(52) U.S. Cl. CPC H04M 3/5238; H04M 3/5166; H04M 3/5183; H04M 3/5235

(57) ABSTRACT

An Artificial Intelligence-based system for managing and directing voice calls during high call volume events. Incoming voice calls are routed to a first control unit. Call data is retrieved from the incoming call and inputted to a throttling engine to predict an intent of the voice call and determine a priority of the voice call. Based on the predicted intent and the priority of the call, a determination is made whether to route the voice call to a second control unit or to disconnect the voice call. Further, additional control units may be implemented to further determine whether to continue to route the call, based on the predicted intent and the verified priority and/or continue to route the call to a routing queue.

### TECHNOLOGICAL FIELD

Example embodiments of the present disclosure relate to AI-based systems and methods for managing and directing voice calls during high call volume events.

### BACKGROUND

Large entities generally provide a phone number for resolving user/caller issues. Callers are directed to a self-service queue or an agent. For call volumes that exceed a defined threshold, the system becomes overwhelmed and is unable to provide support for every caller.

Applicant has identified a number of deficiencies and problems associated with AI-based systems and methods for managing and directing voice calls during high call volume events. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for AI-based management and direction of voice calls during high call volume events.

The present invention provides for a system for managing and directing voice calls during a high call volume event, the system comprising a memory device with computer-readable program code stored thereon, a communication device, and a processing device operatively coupled to the memory device and the communication device. The processing device is configured to execute the computer-readable program code to route an incoming voice call to a first control unit, retrieve call data from the incoming call, input the call data to a throttling engine to predict a first intent of the voice call and determine a priority of the voice call, wherein the throttling engine implements Artificial Intelligence (AI) including one or more Deep Learning (DL) models. Based on the predicted first intent and the priority of the call, the system determines whether to route the voice call to a second control unit. In response to determining to route the voice call to the second control unit, the system routes the voice call to the second control unit and receives additional call data. The system inputs the additional call data, the predicted first intent and the priority to the throttling engine to predict a second intent of the call and verify the priority. Based on the predicted second intent and the verified priority of the voice call, the system determines whether to route the voice call to a third control unit. In response to determining to route the voice call to the third control unit, the system routes the voice call to the third control unit and receive caller data obtained via caller input. The system retrieves system data and inputs the caller data, the predicted second intent and the verified priority to the throttling engine to identify an actual intent of the voice call. Based upon the actual intent of the voice call and the retrieved system data, the system determines whether to route the voice call to a routing queue, and based upon determining to route the voice call to a routing queue, the system routes the call to a routing queue.

The system further comprises an omni processor, wherein the omni processor is configured to direct and manage high call volume events, and wherein executing the instructions further causes the processing device to input retrieved voice call data to a first deep learning model at a first stage, receive a first decision from the throttling engine at the first stage, wherein the decision is whether to route the voice call to a second stage. Based on the decision to route the voice call to the second stage, the omni processor receives additional call data, inputs the additional call data to a second deep learning model at the second stage, and receives a second decision from the throttling engine at the second stage, wherein the decision is whether to route the voice call to a third stage. Based on the decision to proceed to the third stage, the omni processor identifies an actual intent of the voice call, wherein the intent of the call is identified through one or more responses to one or more identifying prompts. The omni processor inputs the actual intent of the voice call to a third deep learning model at the third stage and receives a third decision from the throttling engine at the third stage, wherein the decision is whether to route the voice call to a routing queue.

Further, the call data comprises a phone number of the caller and a phone number called by the caller. The call data further comprises caller data retrieved from a caller record.

The priority of a voice call is based on weighted values assigned to each caller record and intent of the voice call.

The second control unit decides whether to route the voice call to an automated self-service engine or an agent.

The additional call data comprises security information of the caller.

The system is triggered when a total volume of calls received by the system is above a defined threshold.

A determination by the throttling engine at the third control unit is communicated to the first and second control units to update a status of one or more other calls.

The present invention further provides for a computer program product for managing and directing voice calls during a high call volume event, the computer program product comprising a non-transitory computer-readable medium comprising code causing an apparatus to route an incoming voice call to a first control unit and retrieve call data from the incoming call. The computer program product inputs the call data to a throttling engine to predict a first intent of the voice call and determine a priority of the voice call, wherein the throttling engine implements AI including one or more Deep Learning (DL) models. Based on the predicted first intent and the priority of the call, the computer program product determines whether to route the voice call to a second control unit. In response to determining to route the voice call to the second control unit, the voice call is routed to the second control unit and additional call data is received. The computer program product inputs the additional call data, the predicted first intent and the priority to the throttling engine to predict a second intent of the call and verify the priority. Based on the predicted second intent and the verified priority of the voice call, a determination is made whether to route the voice call to a third control unit. In response to determining to route the voice call to the third control unit, the voice call is routed to the third control unit and the computer program product receives caller data obtained via caller input. System data is retrieved, and caller data, the predicted second intent and the verified priority are inputted to the throttling engine to identify an actual intent of the voice call. Based upon the actual intent of the voice call and the retrieved system data, the determination is made whether to route the voice call to a routing queue, and based upon determining to route the voice call to a routing queue, the call is routed to a routing queue.

The present invention further provides for a method for managing and directing voice calls during high call volume events, the method comprising routing an incoming voice call to a first control unit, retrieving call data from the incoming call, inputting the call data to a throttling engine to predict a first intent of the voice call, and determining a priority of the voice call, wherein the throttling engine implements AI including one or more Deep Learning (DL) models. Based on the predicted first intent and the priority of the call, the method determines whether to route the voice call to a second control unit. In response to determining to route the voice call to the second control unit, the method routes the voice call to the second control unit and receives additional call data. The additional call data, the predicted first intent and the priority are inputted to the throttling engine to predict a second intent of the call and verify the priority. Based on the predicted second intent and the verified priority of the voice call, the method determines whether to route the voice call to a third control unit. In response to determining to route the voice call to the third control unit, the voice call is routed to the third control unit. Caller data obtained via caller input is received and system data is retrieved. The caller data, the predicted second intent and the verified priority is inputted to the throttling engine to identify an actual intent of the voice call. Based upon the actual intent of the voice call and the retrieved system data, the method determines whether to route the voice call to a routing queue, and based upon determining to route the voice call to a routing queue, the call is routed to a routing queue.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for AI-based systems and methods for managing and directing voice calls during high call volume events, in accordance with an embodiment of the disclosure;

FIG. 2 illustrates a process flow for AI-based systems and methods for managing and directing voice calls during high call volume events, in accordance with an embodiment of the disclosure.

FIG. 3 illustrates a process flow for routing voice calls during high call volume events, in accordance with an embodiment of the disclosure.

FIG. 4 illustrates an exemplary machine learning (ML) subsystem architecture, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”Like numbers refer to like elements throughout.

As used herein, an “entity” may be any institution employing information technology resources and particularly technology infrastructure configured for processing large amounts of data. Typically, these data can be related to the people who work for the organization, its products or services, the customers, or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary”is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

The present invention provides for a system for managing and directing voice calls during high call volume events. The system routes an incoming voice call to a first control unit and retrieves call data from the incoming call. A throttling engine predicts a first intent of the voice call and determines a priority of the voice call using the retrieved call data. The throttling engine implements Artificial Intelligence (AI) including one or more Deep Learning (DL) models. Based on the predicted first intent and the priority of the call, the throttling engine determines whether to proceed with the call to a second control unit. In response to determining to route the voice call to the second control unit, the throttling engine routes the voice call to the second control unit. The system receives additional call data and predicts a second intent of the voice call and verifies the priority of the voice call. Based on the predicted second intent and verified priority of the voice call, the throttling engine determines whether to route the voice call to a third control unit. In response to determining to route the voice call to the third control unit, the throttling engine routes the voice call to the third control unit and retrieves additional call data via caller input. The system further retrieves system data. The caller data, predicted second intent and the verified priority is inputted to the throttling engine to identify an actual intent of the voice call. Based upon the actual intent of the voice call and the retrieved system data, throttling engine determines whether to route the voice call to a routing queue. Based upon the determination to route the voice call to a routing queue, route the call to a routing queue.

During a high call volume event, defined as a call volume that is above a defined threshold, current call systems cannot process each voice call according to rules of priority. Under this system, high network callers and callers with a high priority intent for the call may not be serviced.

The solution to this problem is an AI-based system for managing and directing voice calls during high call volume events. Data from the voice call, including the number of the caller and the number dialed by the caller, is inputted into an AI-based throttling engine. The throttling engine, based on the call data, predicts a first intent of the voice call, and determines a priority of the call. The throttling engine then determines whether to route the call to the next control unit in the system. In response to determining to route the call to the next control unit, more call data is received, including inputs by the caller, and the additional call data, the predicted first intent and the priority are inputted to the throttling engine. Using the call data, the throttling engine predicts a second intent and verifies a priority of the call. The throttling engine determines whether to route the voice call to the third control unit of the system based on the predicted second intent and the verified priority of the call. The throttling engine receives further call data from one or more caller inputs and retrieves system data. Based on the additional call data, the predicted second intent, and the verified priority, the throttling engine identifies an actual intent of the voice call. The actual intent and retrieved system data are inputted to the throttling engine which determines whether to route the call to a routing queue. Finally, based on determining to route the call to the routing queue, route the call to the routing queue.

Accordingly, the present disclosure describes a system for managing and directing voice calls during a high call volume event. Specifically, the system may route an incoming voice call to an AI-based throttling engine which determines whether the call proceeds ultimately to a routing queue. The incoming voice call is first routed to a first control unit which retrieves information from the call. The system predicts the intent of the voice call and determines a priority of the call. Based on the predicted intent and the priority, the throttling engine determines whether the call proceeds to the next control unit. The system provides for a second and third control unit. At the third control unit, the throttling engine decides whether to route the voice call to a self-service routing queue.

What is more, the present disclosure provides a technical solution to a technical problem. As described herein, the technical problem includes a system which is not designed to handle and process voice calls during a high call volume event. The technical solution presented herein allows for an AI-based throttling engine which processes high call volumes by managing and directing voice calls at three stages. In particular, AI-based throttling engine is an improvement over existing solutions to the problem with call systems during high call volume events, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

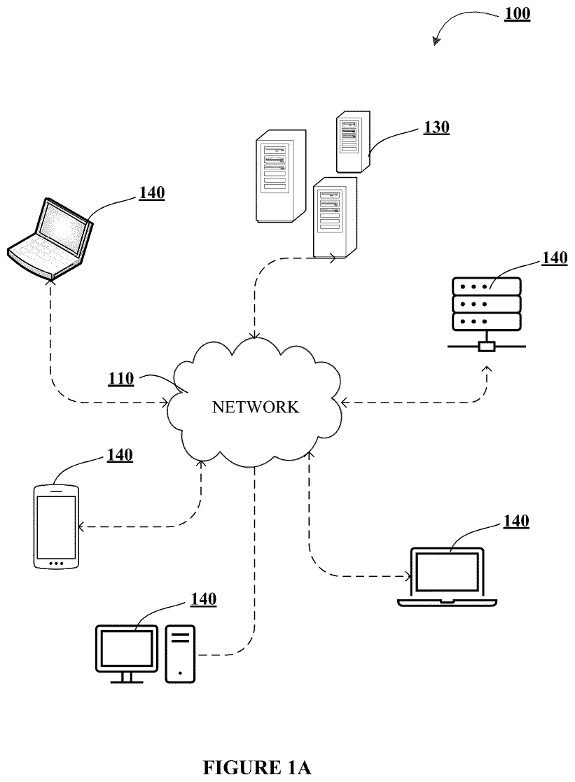

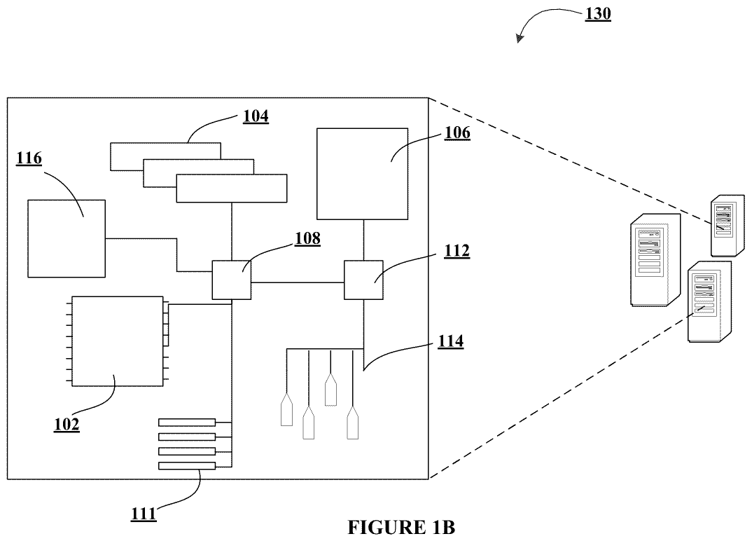

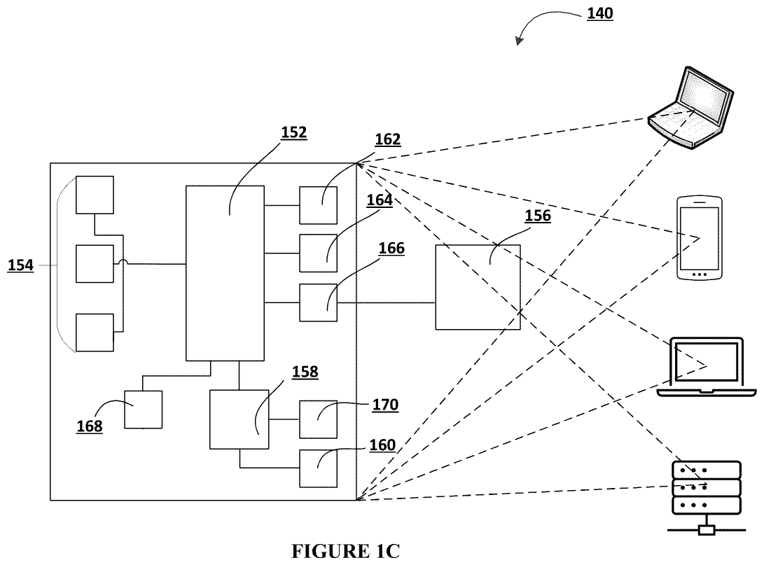

FIGS. 1A-1C illustrate technical components of an exemplary distributed computing environment for AI-based systems and methods for managing and directing voice calls during high call volume events 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low-speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low-speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, or the like) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

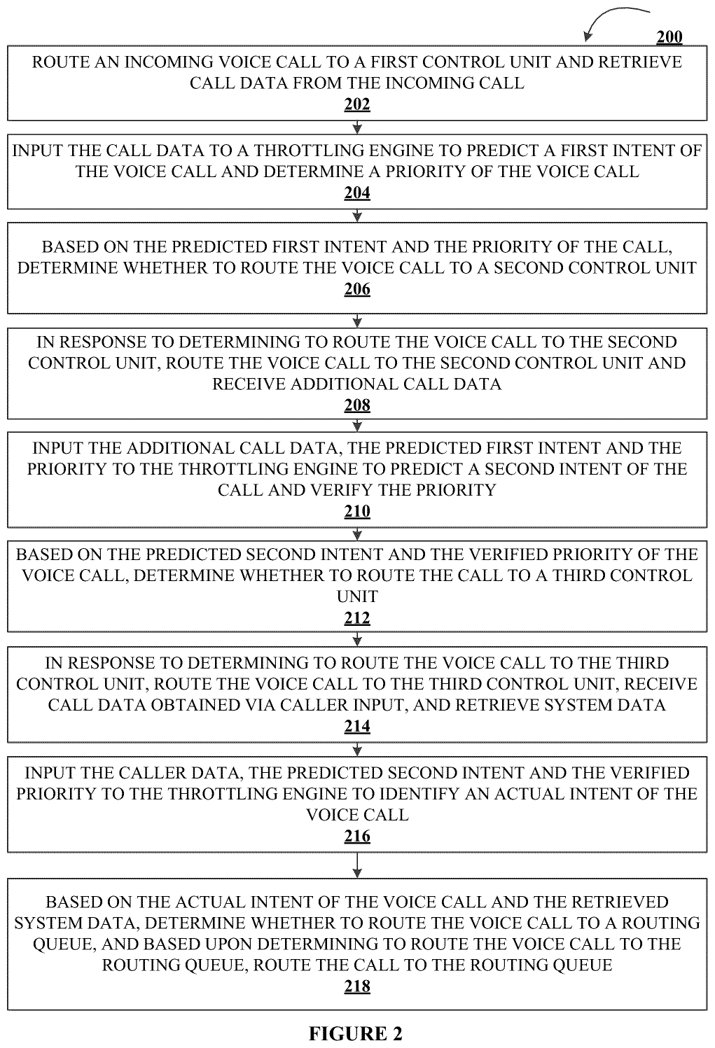

FIG. 2 illustrates a flow diagram of a method 200 for managing and directing voice calls by an AI-based throttling engine. At Event 202, an incoming voice call is routed to a first control unit. In some embodiments, the first control unit is a session border controller (SBC). In this embodiment, the SBC controls admission of calls to the system. In some embodiments, the incoming voice call is routed to the first control unit only if the total volume of calls (calls per second) exceeds a defined threshold. In such embodiments, if the total volume of voice calls is below the defined threshold, the voice call will be routed directly to a routing queue where the caller will be directed to the appropriate resource, which may include an agent, and the call will not be routed through the present system. In some embodiments, the system threshold is determined by the max performance of the system as indicated by the central processing unit (CPU) and random-access memory (RAM) functions. Further, the control unit retrieves data from the voice call. For example, data retrieved from the voice call may include the phone number of the call, the phone number that the caller is calling, and the like. The call data is further used to retrieve a user record associated with the identity of the caller. In some embodiments, the caller's record comprises identifying information including, the name of the caller, one or more account numbers, account history, recent transactions (e.g., resource transactions), and the like.

At Event 204, the call data is inputted to the throttling engine. The AI-based throttling engine uses deep learning algorithms to process voice calls in real time. Based on the call data, the throttling engine predicts a first intent of the voice call and determines a priority of the voice call. The intent of the voice call is the objective for the voice call. In some embodiments, the intent of the call is to resolve one or more issues with one or more accounts (e.g., resource accounts). In some other embodiments, the intent of the call is related to an event. In this embodiment, an event may be a disruption to accessing one or more accounts, disruption to account services, and the like. In some other embodiments, the caller has one or more intents of the call. In some embodiments, an intent of the voice call is to obtain information related to one or more accounts with the entity. In some other embodiments, the intent of the call is to dispute a transaction and the like. In some embodiments, the throttling engine predicts the first intent based on the call data and/or a record of the caller. The priority is determined by the predicted intent and the network of the caller. The network of a caller is based upon the weighted status of the caller. A high network caller is one in which the status of the caller is weighted greater than other callers. Further, high network callers are assigned a higher priority than low network callers. In some embodiments, a threshold is defined for determining whether a caller is considered high network. In some further embodiments, the predicted intent is assigned a priority. For example, an intent of disputing a transaction is assigned a higher priority than an intent of checking the balance of an account. The priority of the intent is determined by the weight of the intent. Higher priority intents are weighted more than lower priority intents. Further, the throttling engine at the first control unit determines the priority of the call based on call statistics which includes the volume of other callers and the order of the individual call.

At Event 206, the throttling engine determines whether to proceed with the voice call to a second control unit based on the predicted intent and the priority of the call. The system will route high priority calls to the second control unit. In some embodiments, a high priority call will be routed to the second control unit even if the intent of the call is weighted less. In the same way, calls whose intent is weighted greater than one or more other callers will be routed to the second control unit even if the caller is low network. For example, an intent of filing a claim is weighted more than checking the account balance of one or more accounts. The system has a defined number of calls the system can process at a given time. The system uses call data, the predicted first intent of each call, the priority of the caller, and the number of callers at a given time to manage how many calls are routed to the second control unit.

At Event 208, in response to the determination to route the voice call to the second control unit, the call is routed to the second control unit and additional call data is received and inputted to the throttling engine. At the second control unit, callers may be prompted to input security information. In one example, the caller is prompted to provide the caller's social security number and/or information associated with the caller's one or more accounts, including authentication credentials. The record associated with a caller is updated with the additional call data. At Event 210, the additional call data, the predicted first intent, and the priority are inputted to the throttling engine to predict a second intent and verify the priority of the call. The second predicted intent is more accurate and closer to an actual intent of the call than the first predicted intent based on the updated inputs to the throttling engine. The throttling engine also verifies the priority of the voice call based on the updated inputs. The throttling engine tracks the predicted second intent and the verified priority to determine the updated status of the call, including whether the caller is a high network caller and whether the intent is weighted more than the intents of one or more other calls.

At Event 212, based on the predicted second intent and the verified priority of the voice call, the throttling engine determines whether to route the call to a third control unit. In some embodiments, the voice call is routed to an automated self-service engine to receive inputs from the caller. In some embodiments, a predicted intent of a first call is weighted more than a predicted intent of a second call. For example, an intent of checking the balance of one or more accounts associated with the caller is given less weight than an intent of disputing a transaction within an account. Similarly, voice calls are given a higher priority over one or more other calls based on the difference in network between the two callers and the relative weight of the intent. In one embodiment, the first call is assigned a higher priority because the caller is a high network caller and/or the intent is weighted more. Conversely, if the intent of the call is weighted more and/or the call is high priority, the voice call will be routed to the third control unit.

At Event 214, in response to determining to route the voice call to the third control unit, the throttling engine routes the voice call to the third control unit and receives call data obtained via input 214. At this stage in the system, call data is any data associated with the call, including data provided by the caller and/or data retrieved from the call. In some embodiments, the caller provides inputs in response to one or more prompts. In this embodiment, the additional call data is received from inputs to the automated self-service engine. In some embodiments, the automated self-service engine is an interactive voice response (IVR) system. The automated self-service engine directs the caller to provide inputs to one or more prompts. In some embodiments, the self-service engine will present a menu of options. In this embodiment, the caller is prompted to make a selection from the menu of options. In some embodiments, the self-service engine may present one or more menus each with a plurality of options to select from. For example, the menu may present one or more menu options and the caller will be prompted to input the number that corresponds to the appropriate option. In some further embodiments, the menu options correspond to different actionable steps. For example, the caller may want to check the balance of one or more accounts or file a claim with the entity. In some embodiments, selection of one option will result in further menu options to select from based on the first selected option. In some embodiments, selection of one menu option or a plurality of menu options results in connecting the voice call directly to an agent. Each selection of a menu option reveals more about the true intent of the voice call.

In some embodiments, the throttling engine at the third control unit considers the additional call data including the transaction history of the caller, how many previous calls the caller has initiated, the intent of the call, and system data. In some embodiments, the call data includes the history and recent activities of the caller regarding one or more accounts. In some further embodiments, call data includes the call statistics, including data retrieved from other calls, including the total volume of calls, the priority of other calls, and the like. System data includes the availability of the system infrastructure to process the call volume at any one point in time. The infrastructure availability includes the limits of the RAM and CPU of the system.

At Event 216, the additional caller data, predicted second intent, and the verified priority are inputted to the throttling engine to identify an actual intent of the voice call. The actual intent of the voice call is the true objective for the call. The throttling engine assesses the accuracy of the first and second predicted intents by comparison to the actual intent. Further, the throttling engine learns from the comparison in order to update and improve the one or more machine learning models.

At Event 218, based on the actual intent of the voice call and the retrieved system data, the throttling engine determines whether to route the voice call to a routing queue, and based upon determining to route the voice call to the routing queue, route the call to the routing queue. At this stage, the caller will be given several menu options to select from. The caller will either select an option from the menu of options. In some embodiments, selection of one of the options of the menu of options will result in connecting the caller to the next available agent. In some embodiments, the agent is a representative associated with the entity where the caller has one or more accounts. In some other embodiments, the caller will select an option from the menu and then will be given a second menu of options to select from. In some further embodiments, the voice call is satisfied by directing to other external resources which are suited to the intent of the call. In this embodiment, the call is not routed to an agent but is concluded after being directed to the appropriate external resource or resources. For example, the caller may be directed to a website address to satisfy the intent of the call.

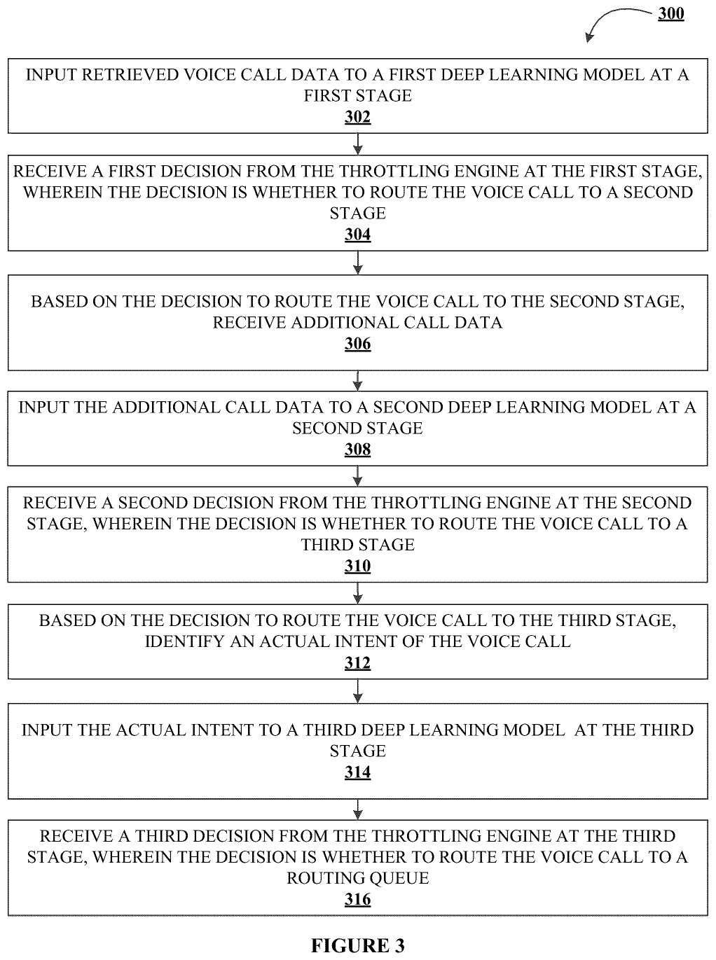

FIG. 3 illustrates a flow diagram of a method 300 for routing voice calls by an omni processor. At Event 302, retrieved voice call data is inputted to a first deep learning model by the omni processor at a first stage. First, the omni processor sends a request to the first deep learning model for a decision, wherein the decision is whether to route the voice call to a second stage. The omni processor records the time stamp of the request. In some embodiments, the omni processor retrieves the ANI, or phone number of the caller, and the DNIS, or the phone number dialed by the caller. The omni processor then routes the data to the first deep learning model. In some embodiments, the first deep learning model comprises a first database.

At Event 304, the omni processor receives a first decision from the throttling engine at the first stage, wherein the decision is whether to route the voice call to a second stage. In some embodiments, the first deep learning model makes the decision based on the call data received, the record of the caller, and the predicted intent and priority of the call. The omni processor then routes the call to the second control unit. In some embodiments, the decision received is a yes or no. For example, the first deep learning model may decide that a high network caller will proceed to the second stage, and in this case, the omni processor will receive a decision of yes. In another example, the first deep learning model may decide that a call with a high priority intent will proceed to the second stage, and the omni processor will receive a decision of yes. In still another example, the first deep learning model may decide that a low priority call will not be routed to the second stage, and the omni processor will receive a decision of no. The omni processor then stores the decision and the time stamp of the decision.

At Event 306, based on the decision to route the voice call to the second stage, additional call data is received. At Event 308, the additional call data is inputted to a second deep learning model at a second stage 308. In some embodiments, the second deep learning model comprises a second database. The omni processor then sends a request for a decision to the second deep learning model, wherein the decision is whether to route the call to a third stage. The omni processor then records the time stamp of the request. At Event 310, a second decision is received from the throttling engine at the second stage, wherein the decision is whether to route the voice call to a third stage. In some embodiments, the second deep learning model makes the decision based on the additional call data, the updated record of the caller, and the predicted intent and priority of the call. In some embodiments, the decision is received as a yes or no. The omni processor records the time stamp of the decision.

At Event 312, based on the decision to route the voice call to the third stage, an actual intent of the voice call is identified. At Event 314, the actual intent is inputted to a third deep learning model at the third stage. In some embodiments, the third deep learning model comprises a third database. The omni processor sends a request to the third deep learning model for a decision, wherein the decision is whether to route the call to a routing queue. The omni processor stores the time stamp of the request. Further, at Event 316, a third decision is received from the throttling engine at the third stage, wherein the decision is whether to route the voice call to a routing queue. In some embodiments, the third deep learning model makes the decision based on the updated record of the caller, the actual intent of the call, the calls in progress status, the available infrastructure, and additional system data. The calls in progress status refers to the number of calls being processed by the system at a given point in time, as well as the stage that each call is currently at in the call system. The available infrastructure refers to the capacity of the computer system to process a given number of calls based on system data, including the RAM and CPU capacities of the call system. In some embodiments, the decision is received as a yes or no. The omni processor records the time stamp of the decision.

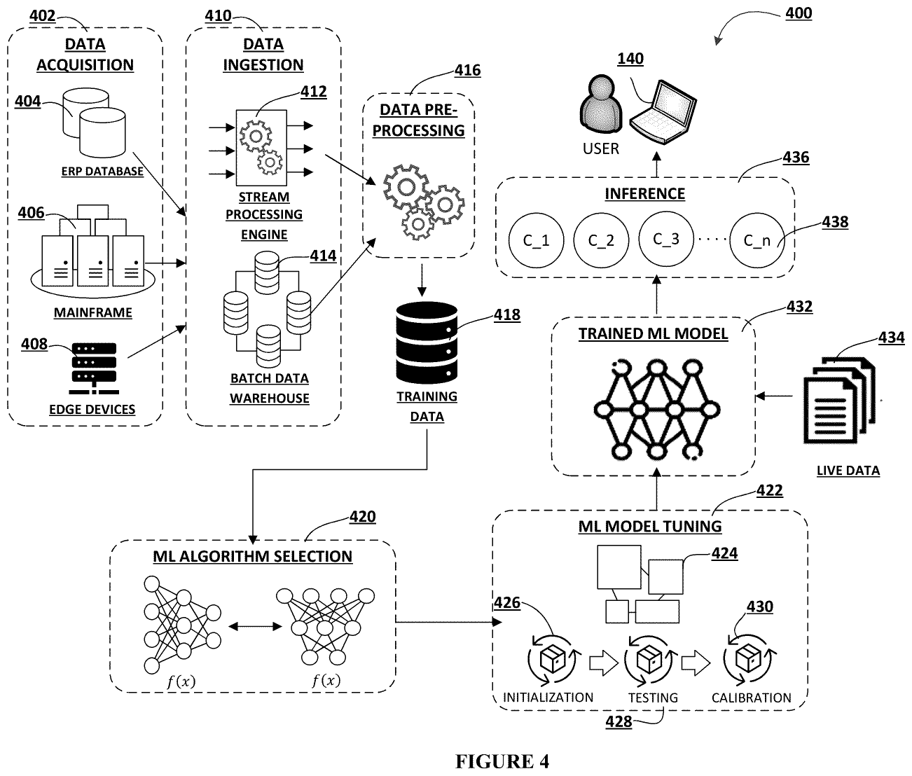

FIG. 4 illustrates an exemplary machine learning (ML) subsystem architecture 400, in accordance with an embodiment of the invention. The machine learning subsystem 400 may include a data acquisition engine 402, data ingestion engine 410, data pre-processing engine 416, ML model tuning engine 422, and inference engine 436.

The data acquisition engine 402 may identify various internal and/or external data sources to generate, test, and/or integrate new features for training the machine learning model 424. These internal and/or external data sources 404, 406, and 408 may be initial locations where the data originates or where physical information is first digitized. The data acquisition engine 402 may identify the location of the data and describe connection characteristics for access and retrieval of data. In some embodiments, data is transported from each data source 404, 406, or 408 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 404, 406, and 408 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 402 from these data sources 404, 406, and 408 may then be transported to the data ingestion engine 410 for further processing.

Depending on the nature of the data imported from the data acquisition engine 402, the data ingestion engine 410 may move the data to a destination for storage or further analysis. Typically, the data imported from the data acquisition engine 402 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 402, the data may be ingested in real-time, using the stream processing engine 412, in batches using the batch data warehouse 414, or a combination of both. The stream processing engine 412 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 414 collects and transfers data in batches according to scheduled intervals, trigger events, or any other logical ordering.

In machine learning, the quality of data and the useful information that can be derived therefrom directly affects the ability of the machine learning model 424 to learn. The data pre-processing engine 416 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 416 may implement feature extraction and/or selection techniques to generate training data 418. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 418 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 422 may be used to train a machine learning model 424 using the training data 418 to make predictions or decisions without explicitly being programmed to do so. The machine learning model 424 represents what was learned by the selected machine learning algorithm 420 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., nïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 422 may repeatedly execute cycles of experimentation 426, testing 428, and tuning 430 to optimize the performance of the machine learning algorithm 420 and refine the results in preparation for deployment of those results for consumption or decision making. To this end, the ML model tuning engine 422 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 418. A fully trained machine learning model 432 is one whose hyperparameters are tuned and model accuracy maximized.

The trained machine learning model 432, similar to any other software application output, can be persisted to storage, file, memory, or application, or looped back into the processing component to be reprocessed. More often, the trained machine learning model 432 is deployed into an existing production environment to make practical business decisions based on live data 434. To this end, the machine learning subsystem 400 uses the inference engine 436 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 438) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 438) live data 434 based on how similar they are to one another to solve exploratory challenges where little is known about the data, provide a description or label (e.g., C_1, C_2 . . . C_n 438) to live data 434, such as in classification, and/or the like. These categorized outputs, groups (clusters), or labels are then presented to the user input system 130. In still other cases, machine learning models that perform regression techniques may use live data 434 to predict or forecast continuous outcomes.

It will be understood that the embodiment of the machine learning subsystem 400 illustrated in FIG. 4 is exemplary and that other embodiments may vary. As another example, in some embodiments, the machine learning subsystem 400 may include more, fewer, or different components.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for managing and directing voice calls during a high call volume event, the system comprising:
a memory device with computer-readable program code stored thereon;
a communication device; and
a processing device operatively coupled to the memory device and the communication device, wherein the processing device is configured to execute the computer-readable program code to:
route an incoming voice call to a first control unit;
retrieve call data from the incoming call;
input the call data to a throttling engine to predict a first intent of the voice call and determine a priority of the voice call, wherein the throttling engine implements Artificial Intelligence (AI) including one or more Deep Learning (DL) models;
based on the predicted first intent and the priority of the call, determine whether to route the voice call to a second control unit;
in response to determining to route the voice call to the second control unit, route the voice call to the second control unit and receive additional call data;
input the additional call data, the predicted first intent and the priority to the throttling engine to predict a second intent of the call and verify the priority;
based on the predicted second intent and the verified priority of the voice call, determine whether to route the voice call to a third control unit;
in response to determining to route the voice call to the third control unit, route the voice call to the third control unit and receive caller data obtained via caller input;
retrieve system data;
input the caller data, the predicted second intent and the verified priority to the throttling engine to identify an actual intent of the voice call;
based upon the actual intent of the voice call and the retrieved system data, determine whether to route the voice call to a routing queue; and
based upon determining to route the voice call to a routing queue, route the call to a routing queue.

2. The system of claim 1, wherein an omni processor is configured to direct and manage high call volume events, and wherein executing the instructions further causes the processing device to:
input retrieved voice call data to a first deep learning model at a first stage;
receive a first decision from the throttling engine at the first stage, wherein the decision is whether to route the voice call to a second stage;
based on the decision to route the voice call to the second stage, receive additional call data;
input the additional call data to a second deep learning model at the second stage;
receive a second decision from the throttling engine at the second stage, wherein the decision is whether to route the voice call to a third stage;
based on the decision to proceed to the third stage, identify an actual intent of the voice call, wherein the intent of the call is identified through one or more responses to one or more identifying prompts;
input the actual intent of the voice call to a third deep learning model at the third stage; and
receive a third decision from the throttling engine at the third stage, wherein the decision is whether to route the voice call to a routing queue.

3. The system of claim 1, wherein the call data comprises a phone number of the caller and a phone number called by the caller.

4. The system of claim 3, wherein the call data further comprises caller data retrieved from a caller record.

5. The system of claim 1, wherein the priority of a voice call is based on weighted values assigned to each caller record and intent of the voice call.

6. The system of claim 1, wherein the second control unit decides whether to route the voice call to an automated self-service engine or an agent.

7. The system of claim 1, wherein the additional call data comprises security information of the caller.

8. The system of claim 1, wherein the system is triggered when a total volume of calls received by the system is above a defined threshold.

9. The system of claim 1, wherein a determination by the throttling engine at the third control unit is communicated to the first and second control units to update a status of one or more other calls.

10. A computer program product for managing and directing voice calls during a high call volume event, the computer program product comprising a non-transitory computer-readable medium comprising code causing an apparatus to:
route an incoming voice call to a first control unit;
retrieve call data from the incoming call;
input the call data to a throttling engine to predict a first intent of the voice call and determine a priority of the voice call, wherein the throttling engine implements Artificial Intelligence (AI) including one or more Deep Learning (DL) models;
based on the predicted first intent and the priority of the call, determine whether to route the voice call to a second control unit;
in response to determining to route the voice call to the second control unit, route the voice call to the second control unit and receive additional call data;
input the additional call data, the predicted first intent and the priority to the throttling engine to predict a second intent of the call and verify the priority;
based on the predicted second intent and the verified priority of the voice call, determine whether to route the voice call to a third control unit;
in response to determining to route the voice call to the third control unit, route the voice call to the third control unit and receive caller data obtained via caller input;
retrieve system data;
input the caller data, the predicted second intent and the verified priority to the throttling engine to identify an actual intent of the voice call;
based upon the actual intent of the voice call and the retrieved system data, determine whether to route the voice call to a routing queue; and
based upon determining to route the voice call to a routing queue, route the call to a routing queue.

11. The computer program product of claim 10, wherein an omni processor is configured to direct and manage high call volume events, and wherein the code further causes the apparatus to:
input retrieved voice call data to a first deep learning model at a first stage;
receive a first decision from the throttling engine at the first stage, wherein the decision is whether to route the voice call to a second stage;
based on the decision to route the voice call to the second stage, receive additional call data;
input the additional call data to a second deep learning model at the second stage;
receive a second decision from the throttling engine at the second stage, wherein the decision is whether to route the voice call to a third stage;
based on the decision to proceed to the third stage, identify an actual intent of the voice call, wherein the intent of the call is identified through one or more responses to one or more identifying prompts;
input the actual intent of the voice call to a third deep learning model at the third stage; and
receive a third decision from the throttling engine at the third stage, wherein the decision is whether to route the voice call to a routing queue.

12. The system of claim 10, wherein the call data comprises a phone number of the caller and a phone number called by the caller.

13. The system of claim 10, wherein the priority of a customer call is based on weighted values assigned to each caller record and intent of the voice call.

14. The system of claim 10, wherein the system is triggered when a total volume of calls received by the system is above a defined threshold.

15. A method for managing and directing voice calls during high call volume events, the method comprising:
routing an incoming voice call to a first control unit;
retrieving call data from the incoming call;
inputting the call data to a throttling engine to predict a first intent of the voice call and determining a priority of the voice call, wherein the throttling engine implements Artificial Intelligence (AI) including one or more Deep Learning (DL) models;
based on the predicted first intent and the priority of the call, determining whether to route the voice call to a second control unit;
in response to determining to route the voice call to the second control unit, routing the voice call to the second control unit and receive additional call data;
inputting the additional call data, the predicted first intent and the priority to the throttling engine to predict a second intent of the call and verify the priority;
based on the predicted second intent and the verified priority of the voice call, determining whether to route the voice call to a third control unit;
in response to determining to route the voice call to the third control unit, routing the voice call to the third control unit and receiving caller data obtained via caller input;
retrieving system data;
inputting the caller data, the predicted second intent and the verified priority to the throttling engine to identify an actual intent of the voice call;
based upon the actual intent of the voice call and the retrieved system data, determining whether to route the voice call to a routing queue; and
based upon determining to route the voice call to a routing queue, routing the call to a routing queue.

16. The method of claim 15, wherein an omni processor is configured to direct and manage high call volume events and wherein the method further comprises:
inputting retrieved voice call data to a first deep learning model at a first stage;
receiving a first decision from the throttling engine at the first stage, wherein the decision is whether to route the voice call to a second stage;
based on the decision to route the voice call to the second stage, receiving additional call data;
inputting the additional call data to a second deep learning model at the second stage;
receiving a second decision from the throttling engine at the second stage, wherein the decision is whether to route the voice call to a third stage;
based on the decision to proceed to the third stage, identifying an actual intent of the voice call, wherein the intent of the call is identified through one or more responses to one or more identifying prompts;
inputting the actual intent of the voice call to a third deep learning model at the third stage; and
receiving a third decision from the throttling engine at the third stage, wherein the decision is whether to route the voice call to a routing queue.

17. The system of claim 15, wherein the call data comprises a phone number of the caller and a phone number called by the caller.

18. The system of claim 17, wherein the call data further comprises caller data retrieved from a caller record.

19. The system of claim 15, wherein the priority of a customer call is based on weighted values assigned to each caller record and intent of the voice call.

20. The system of claim 15, wherein the system is triggered when a total volume of calls received by the system is above a defined threshold.
